(19) United States
(12) Patent Application Publication
(10) Pub. No.: US 2002/0021494 A1
(43) Pub. Date: Feb. 21, 2002

(54) Optical device

(75) Inventor: Darren Chen, Taoyuan Shien (TW)

Correspondence Address: Klein & Szekeres, LLP, Suite 700, 4199 Campus Drive, Irvine, CA, 92612, US

(73) Assignee: Delta Electronics, Inc.

(21) Appl. No.: 09/866,337

(22) Filed: May 25, 2001

(30) Foreign Application Priority Data
Aug. 18, 2000 (TW) 089116818

(51) Int. Cl. G02B 1/10; G11B 5/187

(52) U.S. Cl. 359/580; 359/583; 360/122

(57) ABSTRACT

An optical device used in an optical read/write head is provided. The optical device includes a first optical coating plane and a second optical coating plane for respectively reflecting a first light and a second light to an identical optical axis.

### FIELD OF THE INVENTION

The present invention relates to an optical device, and more particularly to an optical device used in an optical read/write head.

### BACKGROUND OF THE INVENTION

In the conventional CD, CDR, CDRW or DVD, there are several laser sources for reading different discs.

FIG. 1 is a schematic view showing the optical path layout of the optical system used in the optical read/write head of a digital video disc (DVD) according to the prior art. The optical path in front of a reflecting mirror 11 is straightforward. The light from a laser source 13 passes through a beam splitter 12, a collimating lens 14, the reflecting mirror 11 and an objective lens 15, and then the light is projected onto a compact disc 16.

FIG. 2 is a schematic view showing another optical path layout of the optical system used in the optical read/write head of a digital video disc (DVD) according to the prior art. The optical path in front of a reflecting mirror 11 bends in advance. Such optical path is called a bending optical path hereinafter.

Generally, the optical path of an optical read/write head is designed according to the combinations of the foresaid optical paths. Therefore, two beam splitters 12, two laser sources 13 are needed for the design containing two bending optical paths, and a beam splitter 12 and two laser sources 13 are needed for the design containing a straightforward optical path and a bending optical path.

The yield of the optical read/write head will be increased by promoting the quality of the optical path system which has various optical paths. Furthermore, precisely positioning each optical component well is very important for a read/write head and even for the assembly of the optical path system. It is known that the more components the optical system has, the higher the assembling cost is.

The conventional optical path system has several drawbacks, for example the cost of the materials is high, and the process is complicated. It is difficult to regulate the optical axises of different optical paths as an identical optical axis, so that the quality of the read/write head is decreased.

Therefore, the present invention provides an optical device to overcome the foresaid drawbacks.

### SUMMARY OF THE INVENTION

It is therefore an object of the present invention to provide an optical device for improving the quality, the fabricating process and the maintenance of an optical read/write head.

In accordance with the present invention, the optical device includes a first optical coating plane and a second optical coating plane for respectively reflecting a first light and a second light to an identical optical axis.

The optical device is used for an optical read/write head.

Preferably, the first light is a laser beam.

Preferably, the second light is a laser beam.

In addition, the first optical coating plane is parallel to the second optical coating plane. The first light and the second light are generated respectively at different timing.

The first light is directly reflected to the optical axis by the first optical coating plane, and the second light passes through the first optical coating plane and then the second light is reflected to the optical axis by the second optical coating plane.

The first optical coating plane and the second optical coating plane are respectively coated on two opposite sides of a first light-penetrable material.

In addition, the optical device could further include a second light-penetrable material for reflecting a third light to the optical axis.

A third optical coating plane is coated on the second light-penetrable material, and the third light passes through the first optical coating plane and the second optical coating plane and then the third light is reflected to the optical axis by the third optical coating plane.

It is another object of the present invention to provide an optical device having plural optical coating planes for reflecting plural laser beams to an identical optical axis.

It is another object of the present invention to provide an optical device comprising a first optical coating plane and a second optical coating plane coated on two opposite sides of a light-penetrable material for reflecting a first light and a second light to an identical optical axis.

In addition, the optical device further includes a second light-penetrable material for reflecting a third light to the optical axis.

The present invention may best be understood through the following descriptions with reference to the accompanying drawings, in which:

### BRIEF DESCRIPTION OF THE DRAWINGS

FIG. 1 is a schematic view showing an optical path layout of the optical system used in the optical read/write head of a digital video disc (DVD) according to the prior art;

FIG. 2 is a schematic view showing another optical path layout of the optical system used in the optical read/write head of a digital video disc (DVD) according to the prior art;

FIG. 3 is a schematic view showing the optical device according to the preferred embodiment of the present invention;

FIGS. 4 to 7 are the diagrams showing the relationships between the amplification δ/d and the incident angle θ₁ of the light according to the preferred embodiment of the present invention;

FIG. 8 is a schematic view showing the optical device having two light sources according to the present invention;

FIG. 9 is a schematic view showing the optical device having three light sources according to the present invention; and

FIG. 10 is a schematic view showing the optical system including the optical device provided by the present invention, wherein the optical system is used in an optical read/write head.

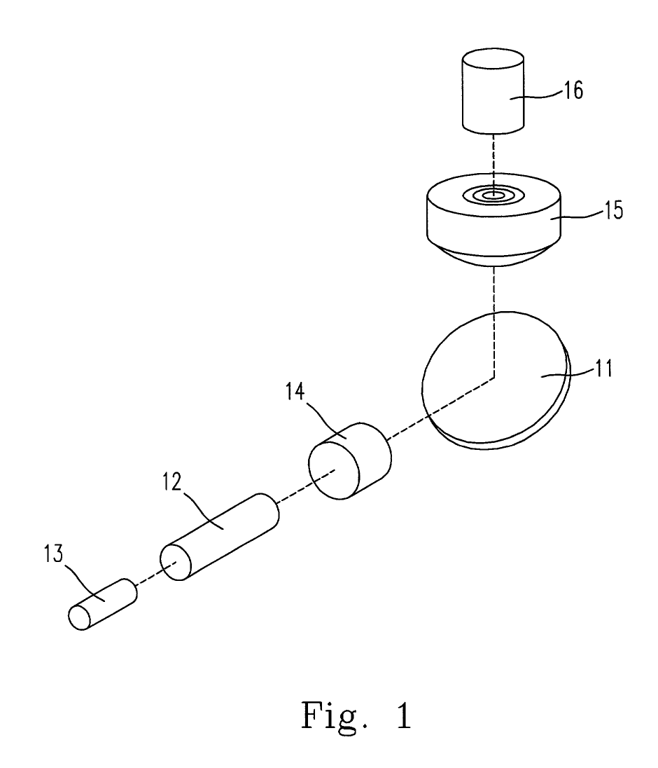

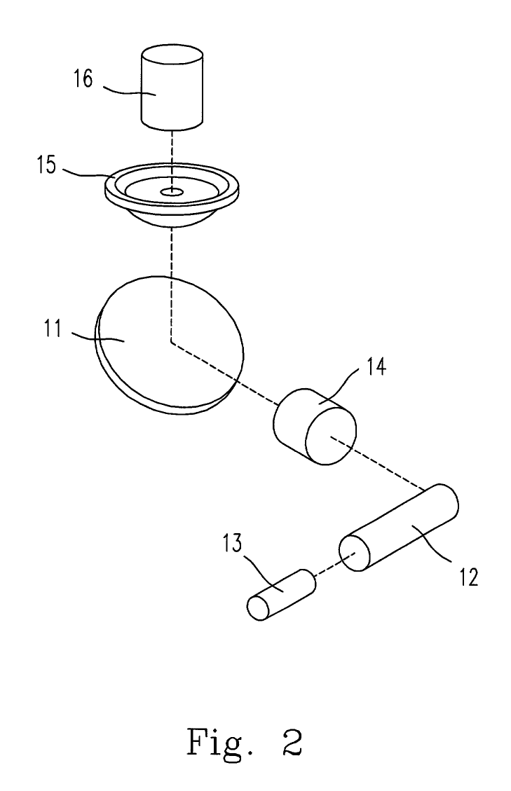

### DETAILED DESCRIPTION OF THE PREFERRED EMBODIMENTS

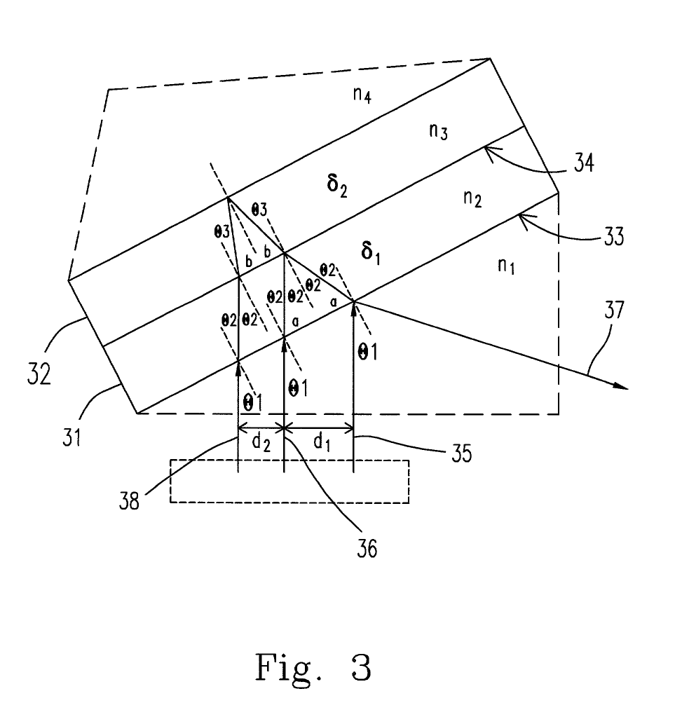

Please refer to FIG. 3. The optical device according to the present invention includes a first light-penetrable material 31 having a first optical coating plane 33 and a second optical coating plane 34 thereon for reflecting a first light 35 and a second light 36 to an optical axis 37.

The optical device provided by the present invention could be used in an optical read/write head of a CD, CDR, CDRW or DVD. The first light 35 and the second light 36 are preferably laser beams. The first optical coating plane 33 is parallel to the second optical coating plane 34. The first light 35 and the second light 36 are produced respectively at different timing.

Certainly, when the optical device provided by the present invention is used in an optical fiber system, it is not restricted that the first optical coating plane 33 is parallel to the second optical coating plane 34. It is not restricted that the first light 35 and the second light 36 are produced respectively at different timing, either.

The first light 35 and the second light 36 are reflected to the optical axis 37 by using the thickness of the first light-penetrable material 31. The optical device according to the present invention further includes a second light-penetrable material 32 for reflecting a third light 38 to the optical axis 37. An optical coating plane (not shown) is coated on the second light-penetrable material 32. The third light 38 is reflected to the optical axis 37 by using the third optical coating plane, the refractive indexes of the second light-penetrable material 32 and the first light-penetrable material 31.

The first light 35, the second light 36 and the third light 38 are reflected to the identical optical axis 37 by using the thickness and the indexes of the first light-penetrable material 31 and the second light-penetrable material 32 and using the coating planes coated on the first light-penetrable material 31 and the second light-penetrable material 32.

The wavelengths of the first light 35, the second light 36 and the third light 38 could be different. The present invention is suitable for using more than three lights, and the optical coating planes could be coated on any light-penetrable material.

According to the optical theory and the coating technique, the lights from different light sources could be regulated to an identical optical axis.

As shown in FIG. 3, the three light sources are put in the same pack, hence the light sources could be considered as an optical component. The three light sources could be disposed according to the requirement for making the three lights to an identical optical axis. The material of the optical components are not restricted.

As shown in FIG. 3, n1, n2, n3 and n4 are respective refractive indexes of air and the different light-penetrable materials. When each parameter (the refractive index n, the angle θ, the thickness δ, the distance d₁ between the first light and the second light, and the distance d₂ between the second light and the third light) conforms with the formulas (a) and (b) as follows, the optical paths of the three lights could be identical.

Formulas (a):

n₁Sinθ₁=n₂Sinθ₂

Tanθ₂=n₁Sinθ₁/\sqrt{n₂²−n₁²Sin²θ₁}

2aCosθ₁d₁

δ₁=a/Tanθ₂

δ₁=d₁/2Cosθ₁Tanθ₂=d₁×\sqrt{n₂²−n₁²Sin²θ}/n₁Sin2θ₁

Formulas (b):

n₃Sinθ₃=n₂Sinθ₂=n₁Sinθ₁

Tanθ₃=n₁Sinθ₁/\sqrt{n₃²−n₁²Sin²θ₁}

2bCosθ₁=d₂

δ₂=b/Tanθ₃

δ₂=d₂/2Cosθ₁Tanθ₃=d₂×\sqrt{n₃²−n₁²Sin²θ₁}/n₁Sin2θ₁

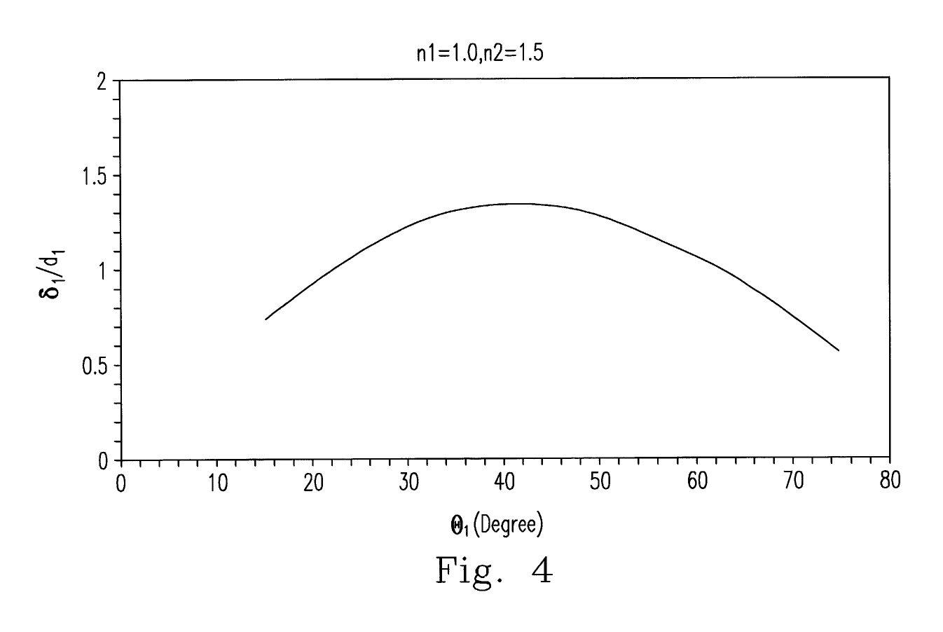

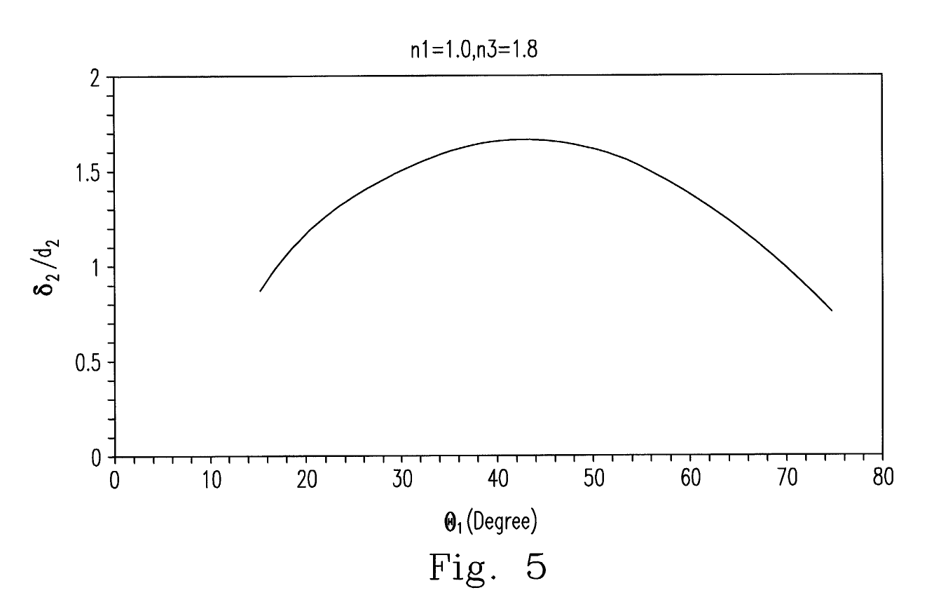

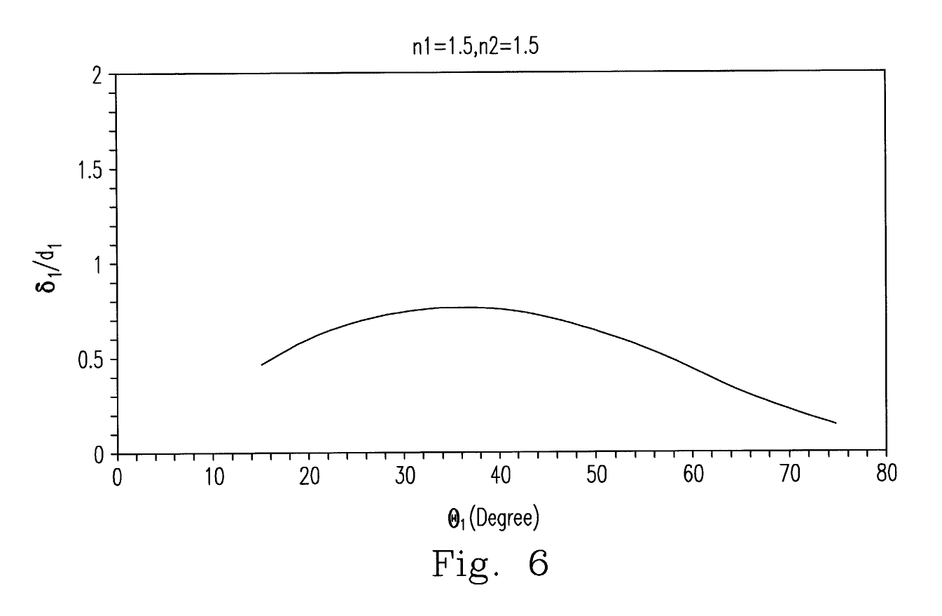

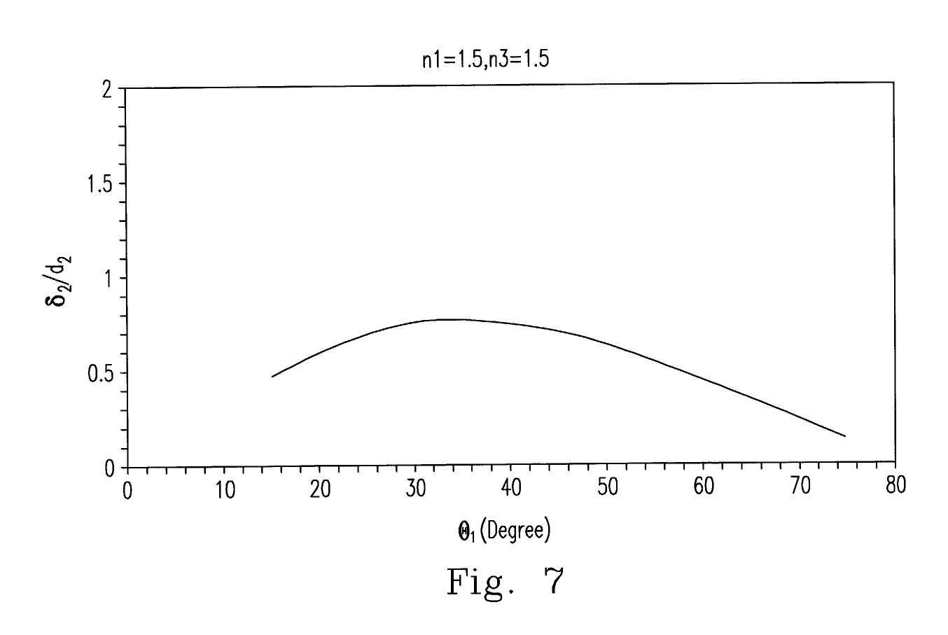

FIGS. 4 to 7 are diagrams showing the relationship between the amplification δ/d and the incident angle θ₁ of the light when the refractive index is constant. For example, the distance between the light sources d and the incident angle θ₁ of the light are selected, and the thickness δ of the light-penetrable material is obtained.

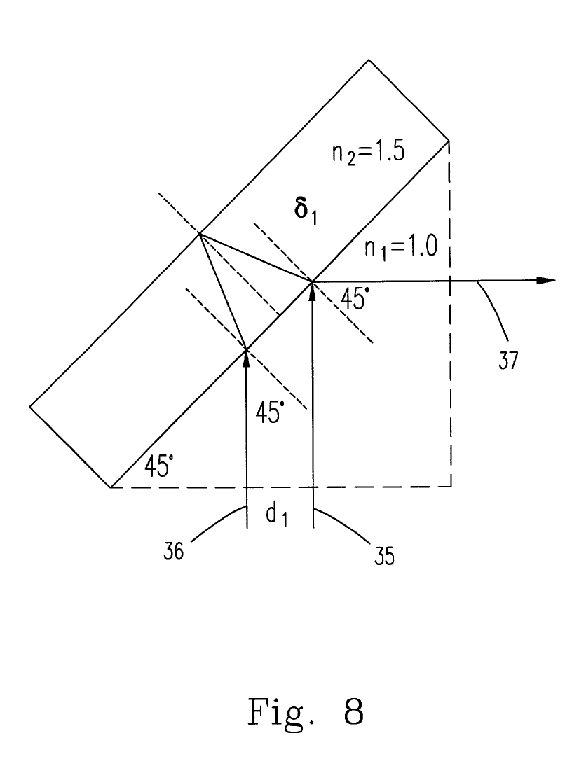

FIG. 8 is a schematic view showing the optical device having two light sources according to the present invention. For the optical device, n₁ is the refractive index of air (n₁=1) and n₂ is the refractive index of glass (n₂=1.5). Hence, just one glass plate is needed for the optical device.

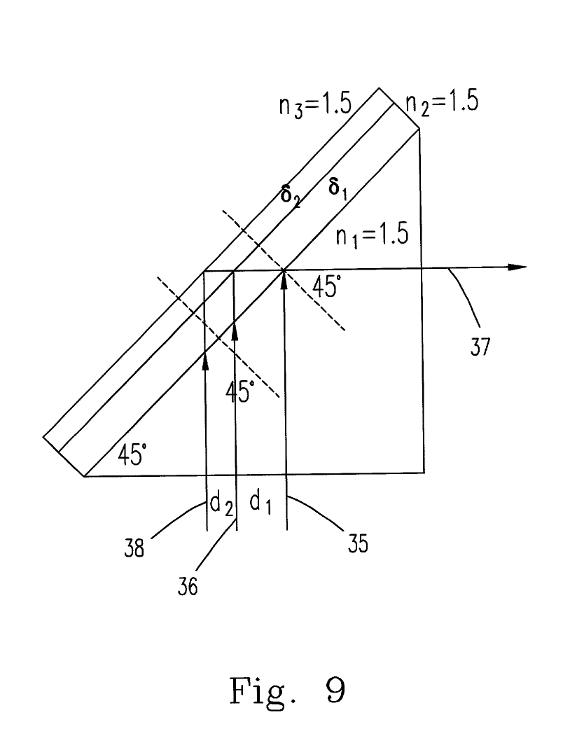

FIG. 9 is a schematic view showing the optical device having three light sources according to the present invention. For the optical device, each value of n₁, n₂ and n₃ is 1.5. Therefore, a prism and two glass plates are needed to be the light-penetrable materials, and the optical coating plates for reflecting the partial light are coated on the light-penetrable materials.

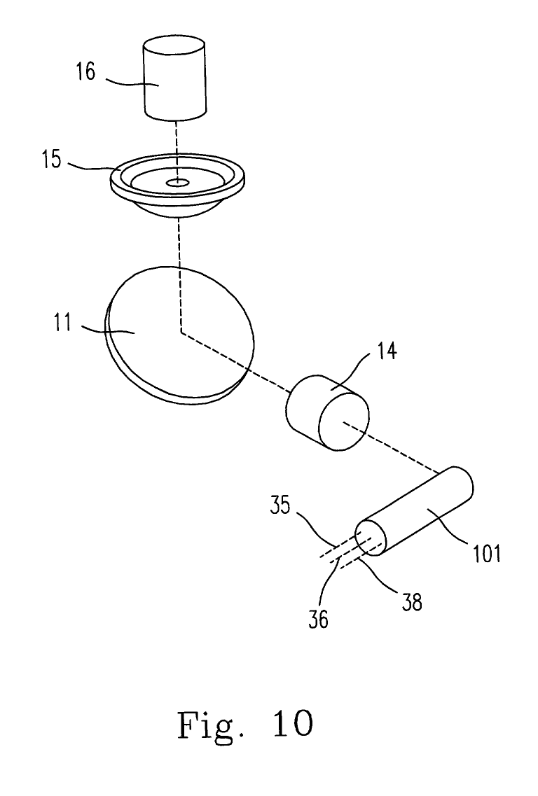

FIG. 10 is a schematic view showing the optical system in an optical read/write head, wherein the optical system has a bending optical path. The decenter correction part 101 is the optical device provided by the present invention.

The optical device provided by the present invention could be used for improving the quality, the fabricating process and the maintenance of the optical read/write head.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. An optical device comprising a first optical coating plane and a second optical coating plane for respectively reflecting a first light and a second light to an identical optical axis.

2. The optical device according to claim 1, wherein said optical device is used for an optical read/write head.

3. The optical device according to claim 1, wherein said first light is a laser beam.

4. The optical device according to claim 1, wherein said second light is a laser beam.

5. The optical device according to claim 1, wherein said first optical coating plane is parallel to said second optical coating plane.

6. The optical device according to claim 1, wherein said first light and said second light are generated respectively at different timing.

7. The optical device according to claim 1, wherein said first light is directly reflect and said seco then said seco optical coating

8. The optical coating plane coated on two

9. The optical light-penetrable

10. The optical coating plane third light pass optical coating plane and then said third light is reflected to said optical axis by said third optical coating plane.

11. An optical device comprising plural optical coating planes for reflecting plural laser beams to an identical optical axis.

12. An optical device comprising a first optical coating plane and a second optical coating plane coated on two opposite sides of a light-penetrable material for reflecting a first light and a second light to an identical optical axis.

13. The optical device according to claim 12, further comprising a second light-penetrable material for reflecting a third light to said optical axis.
